(19) United States
(12) Patent Application Publication
(10) Pub. No.: US 2003/0125968 A1
(43) Pub. Date: Jul. 3, 2003

(54) Method and apparatus for applying extra services to a prepaid cellular subcriber

(75) Inventor: Sukhwinder Uppal, Plano, TX (US)

Correspondence Address: Sidney J. Weatherford, MS/EVW2-C-2, 6300 Legacy Drive, Plano, TX, 75024, US

(73) Assignee: Telefonaktiebolaget L.M. Ericsson

(21) Appl. No.: 10/034,047

(22) Filed: Dec. 27, 2001

(51) Int. Cl. G06F 17/60

(52) U.S. Cl. 705/1

(57) ABSTRACT

A method and apparatus is provided for managing periodic supplementary service charges to a prepaid subscriber account in a telecommunications network. Periodic charges in a prepaid billing system associated with a supplementary service such as call waiting, call forwarding or caller ID are imposed utilizing a predefined tariff rate. The tariff rate includes provisions for credit and for charges that may be applied to a subscriber's PPS account. Charges for call events and for periodic events may be charged to the same account. Additionally, credit and charges may be applied to a call-event sub-account and a supplementary service sub-account. Credit applied to the call-event sub-account may be converted into call time for debiting call-events. Charges associated with supplementary services are periodically deducted from the available funds in the supplementary service sub-account at the beginning or end of each period as set forth in the applicable tariff.

### TECHNICAL FIELD

This invention is related in general to the field of telecommunications. More particularly, the invention is related to a prepaid billing architecture for a wireless telecommunication system.

### BACKGROUND OF THE INVENTION

Cellular or wireless telecommunication systems have recently introduced a prepayment architecture that allows a subscriber to prepay for services. An advantage of prepaid services is that the operator obtains payment in advance saving costly collection services or having to obtain security such as credit card information from a subscriber. The subscriber pays as he uses the system avoiding basic monthly service charges when usage is low.

The current prepaid architecture, in use in many cellular wireless telecommunication systems stores a pre-payment made by a subscriber in a prepaid administration system (PPAS) as a time duration value. In other words, the funds are correlated to specific amounts of time that correspond to rates available to the subscriber, i.e., long distance, local, international, etc. When a prepaid subscriber initiates a call, a switching node of the wireless telecommunication system obtains the credit balance of the subscriber from the stored credit balance as a time interval value. The switching node determines the service charging rate for the call depending on the service the subscriber is requesting and applies this charging rate as a timer decrement. That is, the timer is set at the current credit balance and the balance is decreased at a rate corresponding to the service requested each time that the subscriber uses the service. The caller continues to use the prepaid wireless service up to the amount of funds available in the account. When the timer reaches zero time, representing a nil credit balance, then the call is cleared or ended by the switching node. When the account becomes depleted of funds, additional deposits may be made to replenish the account balance.

There are disadvantages associated with traditional prepaid wireless accounts. Among others, one disadvantage occurs when additional services such as call waiting, call forwarding, caller ID, etc., are desired by the subscriber. These features are customarily charged as monthly fees and consequently are not easily convertible into time units that are deducted from the stored time value that is available in the subscriber's account.

It would be desirable therefore to provide an option in a prepaid system to allow a subscriber to subscribe to services that may provide a separate tariff where the services are billed periodically, i.e., monthly and may not be easily convertible into time related units. Further, it would be desirable and more efficient to have one account to apply both call event and monthly charges to the stored time value.

### SUMMARY OF THE INVENTION

It is an object of the present invention to provide a method and system that allows an operator to apply periodic charges to a prepaid subscriber account.

To address the above-discussed deficiencies of the prior art, the present invention provides a method and apparatus for managing supplementary service charges in a prepaid subscriber account in a telecommunications network. The prepaid subscriber account is linked to a tariff table containing at least one supplementary service. Periodic charges in a prepaid billing system associated with a supplementary service such as call waiting, call forwarding or caller ID are imposed utilizing a predefined tariff rate. A timing function is utilized to signal completion of the time period associated with the supplementary services. Charges associated with supplementary services are periodically deducted from the available funds in the prepaid account at the beginning or end of each predetermined time period as set forth in the tariff.

In one embodiment of the present invention, the PPS account is linked to the supplementary service sub-account and credit and charges related to the supplementary service are made to the sub-account.

In another embodiment of the present invention, an initial signal is transmitted to the timer when the supplementary service is activated.

In a further embodiment of the present invention, a signal indicating the end of a time period is transmitted by the timer.

In yet another embodiment of the present invention, the time period measured between timing signals is checked against a tariff table related to a prepaid subscriber's account. A call data record (detail of charges) is generated according to the rate in the tariff table and applied to the PPS account. The charges may be applied to the main account or to a supplementary services sub-account.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention including its features and advantages, reference is made to the following detailed description of the invention, taken in conjunction with accompanying drawings of which:

FIG. 1 illustrates a high-level block diagram of a portion of a wireless communications system;

FIG. 2 depicts an exemplary high-level block diagram of a prepaid service for a wireless network, according to an embodiment of the present invention;

FIG. 3, illustrates a high-level block diagram of an embodiment of the present invention shown in more detail; and

FIG. 4 depicts a method for applying charges to a prepaid subscriber account according to an embodiment of the present invention.

### DETAILED DESCRIPTION OF THE INVENTION

In the following description, for purposes of explanation and not limitation, specific details are set forth, such as particular architectures, interfaces, circuits, logic modules (implemented in, for example, software, hardware, firmware, some combination thereof, etc.), techniques, etc. in order to provide a thorough understanding of the invention. However, it will be apparent to one of ordinary skill in the art that the present invention may be practiced in other embodiments that depart from these specific details. In other instances, detailed descriptions of well-known methods, devices, logic code (e.g., hardware, software, firmware, etc.), etc., are omitted so as not to obscure the description of the present invention with unnecessary detail.

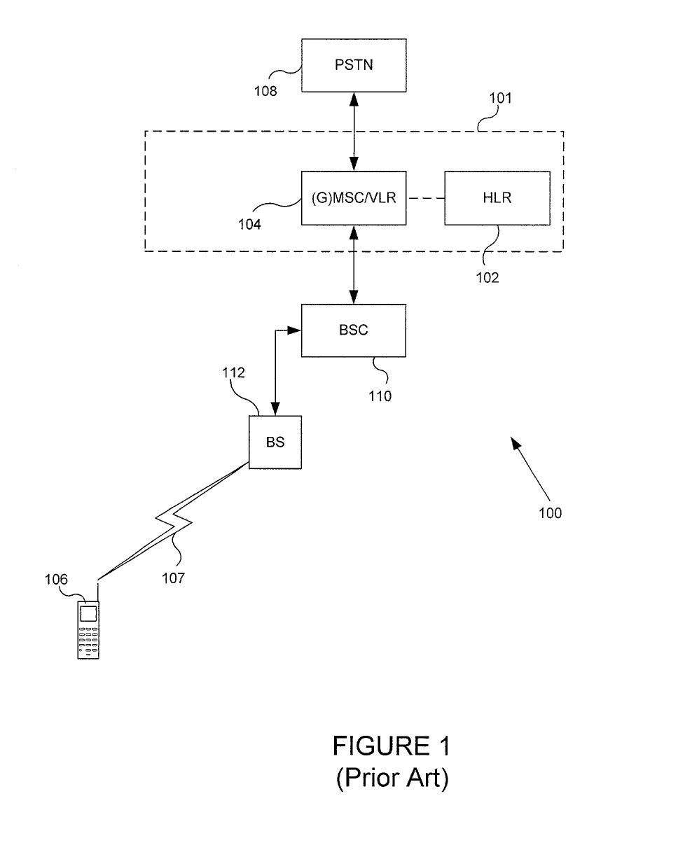

A preferred embodiment of the present invention and its advantages are best understood by referring to FIGS. 1-4 of the drawings, like numerals being used for like and corresponding parts of the various drawings. With reference now to the figures and in particular with reference to FIG. 1, a high-level block diagram of a portion of a communications system is illustrated. Included in communications system 100, is fixed network (PSTN) 108, switching system (SS) 101, Base Station Controller (BSC) 110, and Base Station (BS) 112.

SS 101 includes a plurality of interconnected switching nodes commonly referred to as mobile switching centers (MSCs). Although only MSC 104 is shown, it will be understood that system 101 likely includes many more interconnected nodes. MSC 104 may comprise any one of a number of known telecommunications switching devices, including those commonly used and known in the art for providing either digital or analog cellular telephone service to a plurality of mobile stations (MS) 106. Further, as shown, MSC 104 is shown including the visitor location register (VLR) which is a data base containing information about all the MSs currently located in the MSC area. The gateway (G) designation shown in MSC 104 indicates that a call that is directed to MS 106, is received from PSTN 108 and designates MSC 104 as a gateway MSC. (G)MSC determines the location of MSC 106 and routes the call to the correct MSC. This grouping of functions, shown in FIG. 1 as (G)MSC/VLR 104 will be referred to hereinafter as MSC 104.

Voice trunks (not shown) provide voice and data communications paths used to carry subscriber communications between mobile switching centers. Signaling links (not shown) carry command signals, such as IS-41 or other Signaling System 7 (SS7) messages between MSCs. These signals may be used, for example, in setting up and tearing down voice and data communications links and controlling the provision of calling services to MS 106.

MSC 104 is also connected to home location register (HLR) 102, comprising a database (not shown). The database in HLR 102 stores subscriber information concerning MS 106 such as supplementary services and authentication parameters. Furthermore, there will be information about the location of MS 106. This information, provided by MS 106 via MSC to HLR 102, changes as MS 106 moves around, thus providing means to receive a call at MS 106.

MSC 104 is further connected to at least one associated base station controller (BSC) 110. Only one base station controller is shown connected to MSC 104 in order to simplify the illustration. BSC 110 is then connected to a plurality of base stations (BS) 112 (only one is shown) which operate to effectuate radio frequency communications with proximately located MS 106 over air interface 107. BSC 110 functions in a well-known manner to control this radio frequency communications operation.

Although direct communications links (signaling and/or trunk) are illustrated for system 100 of FIG. 1, it is understood by those skilled in the art that the links are not necessarily direct between the illustrated nodes. The communications may instead pass through many other communications nodes (not shown) of the mobile network, and perhaps even utilize other communications networks (such as the public switched telephone network-PSTN). Illustration of the links in the manner shown in FIG. 1 is therefore by way of simplification of the drawing.

Though not shown, a prepaid system may be included in communication system 100. The prepaid system may include an Internet Protocol (IP) communication or signaling link connected to MSC 104. The signaling link carries real-time call event messages across the IP links using Transmission Control Protocol (TCP). Real-time call event messaging may be utilized by a prepaid administrative system to adjust charges on calls made by the prepaid subscriber.

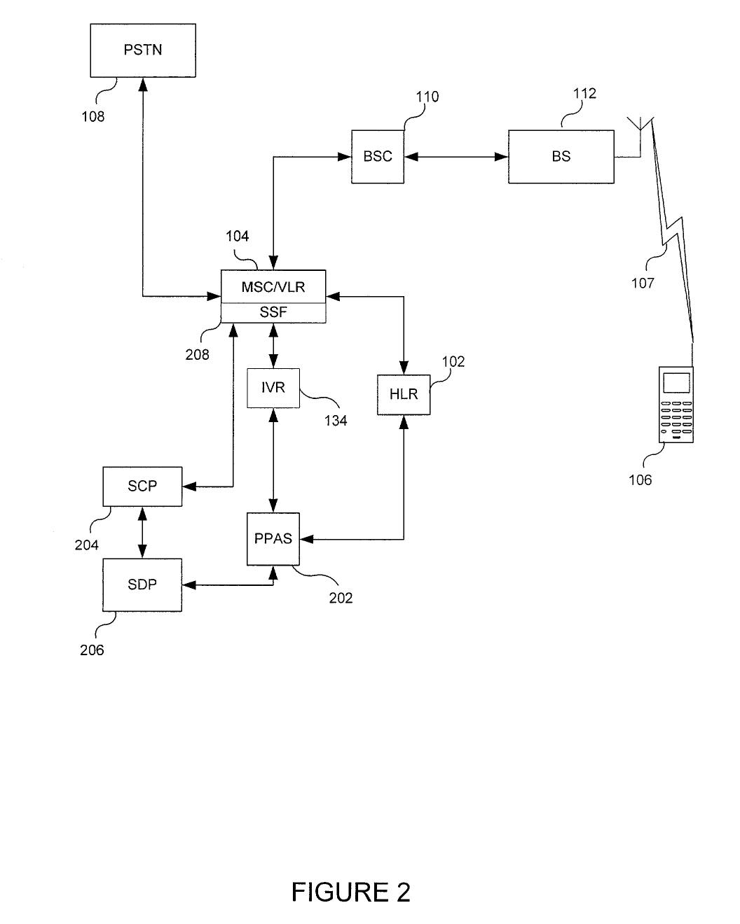

FIG. 2 illustrates an exemplary high-level block diagram of a prepaid service for a wireless network, according to an embodiment of the present invention. MS 106 may be in communication with BS 112 via air interface 107. BS 112 provides a communication link with MSC 104 via BSC 110. Calls made to MS 106 (i.e., calls from PSTN 108) may also be routed via MSC 104. All prepaid service (PPS) calls, to or from MS 106, are routed by MSC 104 to service switching function (SSF) 208. Interactive voice response (IVR) 201 may be used to guide a PPS subscriber (hereinafter, referred to as MS 106) that has called the service provider's service number. By giving announcements and voice prompts to the subscriber and receiving DTMF in response, IVR 201 helps the caller to interact with PPAS 202 with account balance inquiries, expiration date inquiries and refill procedures.

SSF 208 may be integrated in MSC 104 and is capable of handling service execution in service control point (SCP) 204. SSF 208 initiates service execution in SCP 204. SCP 204 directs SSF 208 on how to handle the call. SSF 208, among other duties in the prepaid system, reports call duration, supervises calls and receives announcement codes from Service Data Point (SDP) 206.

A Service Control Function (SCF)(not shown) executes an Intelligent Network (IN) application located in SCP 204. Utilizing the IN application, SCP 204 interacts with SDP 206 to retrieve data necessary for a PPS call and sends operations to SDP 206 for updating data and for statistical purposes. SCP 204 controls the call by interacting with SSF 208. SCP 204 interrogates, monitors and may generate Call Detail Records (CDRs) for each call. CDRs may also be generated and applied by SDP 206.

SSF 208 triggers SCP 204 to execute the prepaid service routine upon detecting a prepaid call, either incoming or outgoing. SDP 206 rates calls by applying rate charging analysis and also reserves funds/time value to the prepaid account. SCP 204 reacts with SDP 206 to retrieve data necessary for a PPS call and sends reports to SDP 206 for updating data and for statistical purposes. All PPS related subscriber identifiers may be stored in SDP 206. HLR 102 stores all PPS subscriptions just like ordinary subscriptions. HLR 102 may also be used for barring terminating calls to a PPS account.

SSF 208 also provides for the coordination of supplementary services. PPAS 202 handles the administrative functions of the prepaid system including subscriber provisioning, account expiration dates, service class data and balance inquiries.

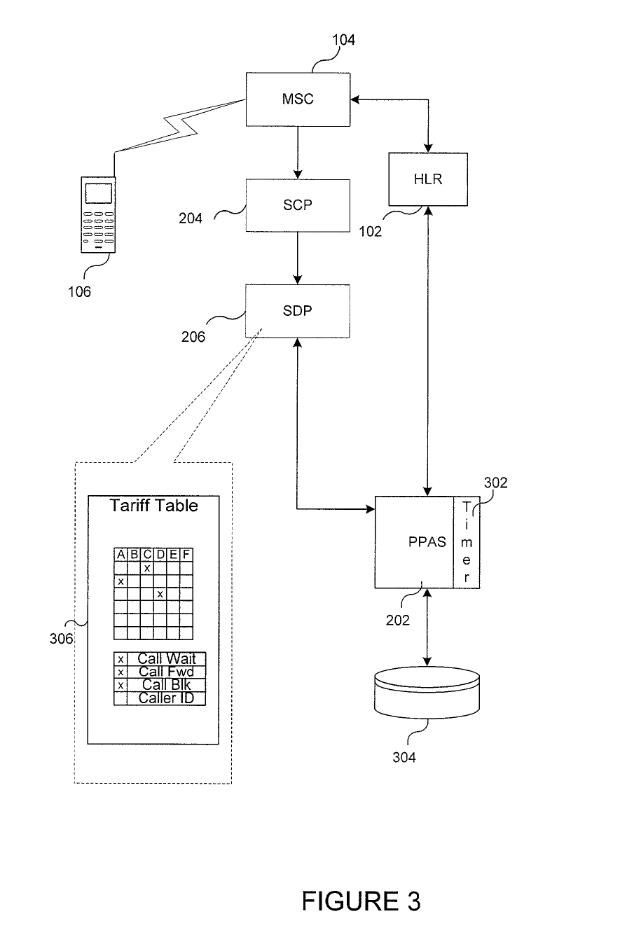

Reference is now made to FIG. 3 wherein like communication links and network points identified in FIG. 1 and FIG. 2 have been identified in FIG. 3 using like numbers and acronyms. FIG. 3 illustrates a high-level block diagram of an embodiment of the present invention shown in more detail. MSC 104 includes a call control unit (not shown) for permitting a call to be set up with the prepaid subscriber when a sufficient prepaid service credit balance exists and for terminating the call when the prepaid service credit balance is nil or reaches a predetermined amount.

HLR 102 is connected to MSC 104 and PPAS 202 for identifying MS 106, a prepaid subscriber, to mobile switching center 104. Further, HLR 102 may be used for instructing PPAS 202 to communicate other messages from PPAS 202 to mobile switching center 104. PPAS 202 and database 304 may store information related to the prepaid service credit balance of the prepaid subscriber. Database 304 may be updated with new credit balance information received from IVR 201 (not shown here, see FIG. 2).

In a call-event (local call, long distance call) PPAS 202 accesses database 304 and sends subscriber credit balance information in the form of a time interval signal to SDP 206. In this embodiment, timer 302 is shown as an integral part of PPAS 202. Those skilled in the art will understand that timer 302 may not necessarily be located in PPAS 202, but may be in another location.

An initial charge rate is communicated to timer 302 from tariff table 306 that is associated with the services that the prepaid subscriber is using at call set up. Timer 302 during a PPS call receives a timing rate, decreasing signal or rate decrement value determined from tariff table 306, which decreases the time value in the PPS account as the prepaid subscriber continues with the call. At the end of the call, timer 302 forwards a signal, to database 304, that is associated with the unused time still available as credit to the prepaid subscriber. When the credit balance in database 306 is increased during a call, then the signal is sent to timer 302 to reset or increment the time interval credit balance in accordance with the credit added to the prepaid subscriber's account.

In the present invention, timer 302 may further be used for timing the supplementary services periods which may consist of set fees applied on a periodic basis (there may also be a timer for call-events and a timer for supplementary services). In the present invention, upon receipt of a timing signal associated with a supplementary service, SDP 206 retrieves the appropriate prepaid tariff information, associated with MS 106, from tariff table 306. Utilizing timer 302, PPAS 202 may send an initial signal to SDP 206 that relates to the initiation of the supplementary service associated with MS 106. Timer 302 will send a timing signal at the end of the first period to designate completion of the initial period as set forth in the associated tariff. Timer 302 will then be reset and repeat the timing cycle according to the tariff table and the supplementary services associated with the prepaid subscriber.

The time period defined by the initial and subsequent timing signals is compared with the tariff table entries to determine the supplementary service associated with the prepaid subscriber's account. The charge associated with the associated supplementary service is determined. SDP 206 than reduces the subscriber's account according to the related tariff amount in tariff table 306.

Time keeping for the periodic charge is simple and relates to weekly, monthly, quarterly or annual fees for services that aren't easily converted into time values (used to reduce PPS accounts during a call-event).

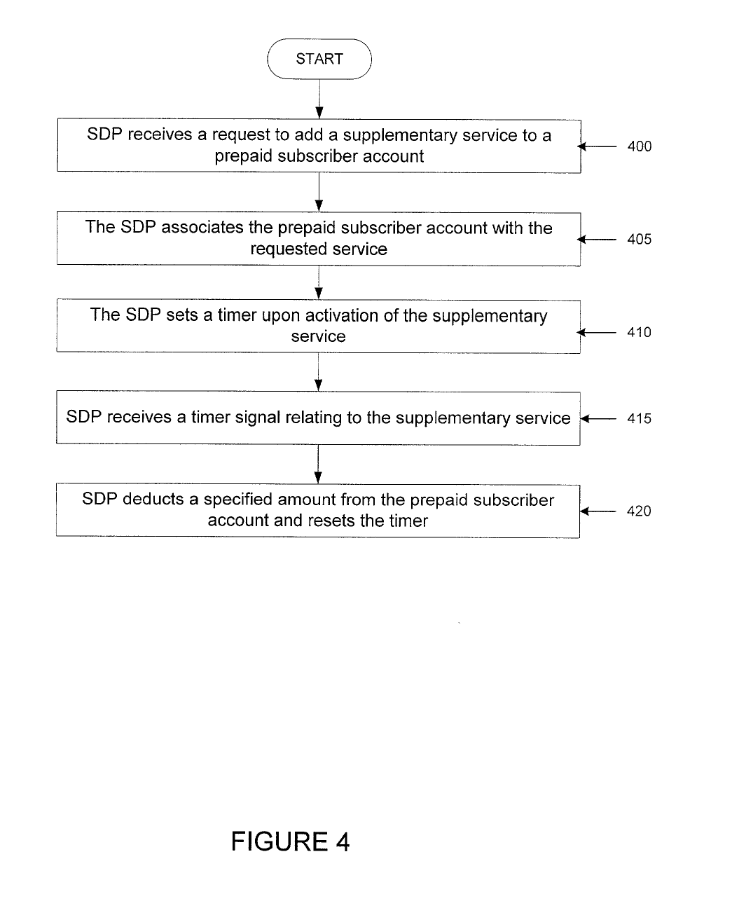

FIG. 4 illustrates a method for applying charges to a prepaid subscriber account according to an embodiment of the present invention. The process begins when a request is received to open a new prepaid subscriber account including supplementary services or to add a supplementary service to an existing prepaid subscriber account. In an exemplary embodiment the supplementary services addition is handled by the SDP. A supplementary service may be any of a group of services available in a telecommunications network such as call forwarding, call blocking, caller ID, etc. The common attribute of these services is that the billing is a periodic charge, generally monthly, and the funds in the prepaid account is not easily converted to the periodic lump sum reduction required for payment of the supplementary services charge (process step 400).

The SDP links the prepaid subscriber account with an appropriate rate base or tariff table that contains supplementary service rates. The present invention utilizes a tariff table in the SDP which may also include a fee schedule for call-event rates such as the long distance rate, the minute rate when in the home network, roaming rate, etc. Additionally, the present invention provides a rate in the tariff table that is related to monthly or periodic, lump sum charges that are applicable to prepaid accounts. In a new account the SDP associates the prepaid account with the appropriate call-event rates, the contracted monthly rates and the requested supplementary service rates. In an existing account, the SDP would associate the prepaid account with the supplementary services rate schedule. Funds may be deposited to the subscriber's account, which may include a call-event sub-account and a supplementary service sub-account (process step 405).

A timer is provided to measure the period associated with the supplementary service. The timer may be incorporated in the SDP or external to the SDP, as shown in FIG. 3, where the timer function is provided in the PPAS. In the SDP, a timing application accessible in the operating system may be utilized to provide the necessary periodic signals to the SDP. A separate timing function is provided in the exemplary embodiment for measuring the regular time periods for the supplementary service.

When the service is first activated a signal is sent to the SDP to indicate the beginning of the period to be charged to the subscriber's account. If the timing signal is present in the SDP, the SDP simply activates the timing application. If the timing function is external to the SDP, a signal is sent to the external timing function to indicate the beginning of the initial time period (process step 410).

As the first supplementary service period concludes a signal is sent to the SDP. The SDP monitors incoming signals and when the signal marking the end of the service period is detected, the SDP accesses the rate table associated with the PPS account. A Call Data Record (CDR), containing charging information, is generated and processed (process step 415).

The SDP deducts the amount specified in the CDR from the subscriber's supplementary service sub-account. If the supplementary service is not associated with a sub-account to the PPS account, the amount is deducted from the PPS account. The SDP then sends a signal that resets the timer (process step 420). In conjunction with the accounting for the supplementary service account, the same timer or another specified timer may also handle call-events by reducing the time value stored in the subscriber's call-event sub-account.

In summary, the present invention provides a method and apparatus for supplying periodically billed supplementary services to a prepaid subscriber account. Normally, the prepaid subscriber account is paid in advance and the amount is credited to the account utilizing time-based credits. As call events occur, the time in the account is reduced to pay for the call events. In the present invention supplementary services are normally billed on a monthly basis. The supplementary service charges are timed separately from call events and billed according to a separate rate table/tariff table. The present invention provides a solution that allows a prepaid customer to pay monthly charges for supplementary services from a single prepaid account.

Although preferred embodiment(s) of the methods, systems, and arrangements of the present invention have been illustrated in the accompanying Drawings and described in the foregoing Detailed Description, it will be understood that the present invention is not limited to the embodiment(s) disclosed. The present invention is capable of numerous rearrangements, modifications, and substitutions without departing from the spirit and scope of the present invention as set forth and defined by the following claims.

What is claimed is:

1. A method for managing a prepaid subscriber (PPS) account in a telecommunication system, the method comprising the steps of:
establishing a credit balance in said PPS account;
linking at least one supplementary service to said PPS account wherein a tariff table for said at least one supplementary service includes a rate comprising a periodic charge associated with a predetermined time period;
determining that said predetermined time period associated with said supplementary service is complete; and
applying said associated periodic charge to said PPS account.

2. The method as set forth in claim 1, wherein linking said at least one supplementary service to said subscriber account further comprises linking said PPS account to a supplementary service sub-account and a call-event sub-account.

3. The method as set forth in claim 1, wherein applying said periodic charge to said PPS account further comprises applying said periodic charge to said supplementary service sub-account.

4. The method as set forth in claim 1, further comprising the step of transmitting an initial signal upon activation of said supplementary service sub-account.

5. The method as set forth in claim 1 further comprising the steps of:
utilizing a timing function for measuring said predetermined time period; and
sending a signal subsequent to said initial signal wherein said subsequent signal indicates the end of said time period.

6. The method as set forth in claim 4 further comprising the steps of:
detecting said initial signal;
detecting said subsequent signal;
determining that said predetermined time period has passed; and
generating a call data record associated with said supplementary service, according to said tariff table, for application to said PPS account.

7. The method as set forth in claim 6, further comprising the step of applying said call data record to said PPS account.

8. The method as set forth in claim 7, further comprising the step of linking said supplementary services to said prepaid subscriber account wherein said prepaid subscriber account is stored on a home location register.

9. An apparatus for managing a prepaid subscriber account in a wireless telecommunication system, comprising:
a prepaid administration system coupled with said prepaid subscriber account;
a means for charging and reducing funds in said prepaid subscriber account;
a database for storing tariff information associated with said prepaid subscriber account wherein said tariff information comprises:
a first value for call events; and
a second value for periodic charges related to said supplementary service sub-account; and
a timer for determining a time period related to said periodic charges.

10. The apparatus as set forth in claim 9, wherein said PPS account comprises a supplementary service sub-account and a call-event sub-account.

11. The apparatus as set forth in claim 10, further comprising a means for applying said periodic charges to said supplementary service sub-account.

12. The apparatus as set forth in claim 9 further comprising a signal generating means for generating an initial signal upon activation of said supplementary service sub-account.

13. The apparatus as set forth in claim 12 further comprising:
a timing function for measuring said predetermined time period; and
detection means for detecting said initial signal and a signal corresponding with the end of said time period.

14. The apparatus as set forth in claim 13, further comprising means for generating a call data record associated with said supplementary service, according to said tariff table, for application to said PPS account.

15. The apparatus as set forth in claim 13, further comprising means for applying said call data record to said prepaid subscriber account.

16. A computer program product within a computer usable medium for managing a prepaid subscriber (PPS) account in a telecommunication system, comprising the steps of:
instructions within the computer usable medium for establishing a credit balance in said PPS account;
instructions within the computer usable medium for linking at least one supplementary service to said subscriber account wherein a tariff table for said at least one supplementary service includes a rate comprising a periodic call data record associated with a predetermined time period;
instructions within the computer usable medium for determining that said predetermined time period associated with said supplementary service is complete; and
instructions within the computer usable medium for applying said associated periodic charge to said PPS account.

17. The computer program product as set forth in claim 16 wherein instructions for linking said at least one supplementary service to said subscriber account further comprises instructions for linking said PPS account to a supplementary service sub-account and a call-event sub-account.

18. The computer program product as set forth in claim 16, wherein instructions for applying said periodic charge to said PPS account further comprises instructions applying said periodic charge to said supplementary service sub-account.

19. The computer program product as set forth in claim 17 further comprising:
instructions within the computer usable medium for utilizing a timing function for measuring said predetermined time period; and
instructions within the computer usable medium for sending a signal subsequent to said initial signal wherein said subsequent signal indicates the end of said time period.

20. The computer program product as set forth in claim 19 further comprising:
instructions within the computer usable medium for detecting said initial signal;
instructions within the computer usable medium for detecting said subsequent signal; and
instructions within the computer usable medium for determining that said predetermined time period has passed; and
instructions within the computer usable medium for generating a call data record associated with said supplementary service according to said tariff table for application to said PPS account.

21. The computer program product as set forth in claim 20, further comprising instructions within the computer usable medium for applying said call data record to said PPS account.
